(19) United States
(12) Patent Application Publication
(10) Pub. No.: US 2019/0350809 A1
(43) Pub. Date: Nov. 21, 2019

(54) DEVICES AND METHODS FOR MULTI-LIQUID STORAGE AND MIXING

(71) Applicant: Alcon Inc., Fribourg (CH)

(72) Inventors: Ahmad R. Hadba, Fort Worth, TX (US); Michael Piazza, Crowley, TX (US)

(21) Appl. No.: 16/406,679

(22) Filed: May 8, 2019

Related U.S. Application Data
(60) Provisional application No. 62/674,185, filed on May 21, 2018.

(51) Int. Cl. A61J 1/20; A61J 1/14; A61J 1/10

(52) U.S. Cl. CPC A61J 1/2093; A61J 1/1412; A61J 1/1462; A61J 1/2041; A61J 1/1481; A61J 1/10

(57) ABSTRACT

Various embodiments are generally directed to devices and methods for multi-liquid storage and mixing, such as with a medical liquid packaging device (MLPD), for instance. Some embodiments are particularly directed to an MLPD that includes first and second reservoirs that store separate liquids that may be selectively combined prior to administration to a patient. In one or more embodiments, for example, a device for medical liquid packaging may include a first reservoir and a dispensing port with a second reservoir. In a first state, a flow preventer separates the liquid in the first reservoir from the liquid in the second reservoir. Actuation of an actuator, such as by depression of the actuator, dislodges the flow preventer, allowing fluid communication between the first reservoir and the second reservoir.

### PRIORITY CLAIM

This application claims the benefit of priority of U.S. Provisional Patent Application Ser. No. 62/674,185 titled “Devices and Methods for Multi-Liquid Storage and Mixing,” filed on May 21, 2018, whose inventors are Michael Piazza and Ahmad R. Hadba, which is hereby incorporated by reference in its entirety as though fully and completely set forth herein.

### BACKGROUND

Often medical procedures, such as surgery, involve the administration of one or more liquids to a patient. For example, a surgery may utilize intravenous therapy. Generally, an intravenous therapy is a therapy that delivers liquid substances directly into the vein of a patient during a medical procedure, such as through a needle or port. The intravenous route can be the fastest way to deliver medications and/or provide fluids throughout the body of a patient. One or more liquids may also be administered to other parts of the patient. For example, the liquid could be used to irrigate the eye or be infused into the eye. Sometimes the liquid substance administered to a patient may include a mixture of distinct types of liquids. Further, the mixture may include specific ratios of the distinct types of liquids

### BRIEF DESCRIPTION OF THE DRAWINGS

FIG. 1 illustrates an exemplary medical liquid packaging device (MLPD) according to one or more embodiments described herein.

FIG. 2 illustrates an exemplary actuator according to one or more embodiments described herein.

FIGS. 3A-3C illustrate exemplary operational states of an MLPD according to one or more embodiments described herein.

FIGS. 4A and 4B illustrate an exemplary MLPD according to one or more embodiments described herein.

FIGS. 5A-5C illustrate an exemplary dispensing port according to one or more embodiments described herein.

FIGS. 6A-6C illustrate an exemplary MLPD according to one or more embodiments described herein.

### DETAILED DESCRIPTION

Various embodiments are generally directed to techniques and devices for multi-liquid storage and mixing, such as with a medical liquid packaging device (MLPD), for instance. Some embodiments are particularly directed to an MLPD that includes first and second reservoirs that store separate liquids that may be selectively combined prior to administration to a patient. In one or more embodiments, a device for medical liquid packaging may include a reservoir assembly and an actuator. In some embodiments, the reservoir assembly may include a top end with a port and a bottom end. In some such embodiments, a first reservoir may be disposed within the reservoir assembly proximate the bottom end and a second reservoir may be disposed within the reservoir assembly proximate the top end of the reservoir assembly. In various embodiments, the first reservoir may store a first liquid and the second reservoir may store a second liquid. In one or more embodiments, an actuator may be coupled to the port of the reservoir assembly. In one or more such embodiments, the actuator may have a first state and a second state wherein, in the first state, a flow preventer is disposed between the first and second reservoirs to block fluid communication therebetween, and, in the second state, the flow preventer is dislodged from between the first and second reservoirs to provide fluid communication therebetween.

Intravenous therapies that have utilized a mixture of multiple liquids have had some challenges or drawbacks, such as steps or time involved in deployment, efficacy issues, safety issues and/or decreased shelf life. For instance, a mixture may require combining different liquids in specific ratios for the intravenous therapy to be effective. In some instances, combination of the different liquids may be performed manually on-site, leading to unnecessary opportunities for human error. In various instances, a transfer spike may be required to empty the contents of one product (or liquid) into a container of another product, presenting unwanted spill risks. Additionally, or alternatively, premixing two liquids can drastically reduce the mixture's useful shelf life. In various instances, different liquids may separate apart prior to administration, leading to potentially dangerous medical complications. The challenges may result from an inability of a medical liquid packaging device to be able to store different constituents of a mixture separately, in the appropriate proportions, until a user activates the mixtures. For instance, different constituents of a mixture may be stored in different containers, and measured and combined by a pharmacist, requiring excessive lead and prep times. These and other factors may result in poorly designed, inefficient, and potentially dangerous medical liquid packaging devices with limited flexibility, deficient performance, and safety concerns. Such limitations can reduce the capabilities, usability, and applicability of intravenous therapies, contributing to inefficient devices with limited abilities.

Various embodiments described herein include a medical liquid packaging device with first and second reservoirs for storing different liquids. In various such embodiments, actuation of an actuator included in the MLPD may establish fluid communication between the first and second reservoirs to combine different liquids into a mixture. For instance, the first reservoir may include an irrigating liquid and the second reservoir may include a liquid additive for the irrigating liquid. In some embodiments, the first and second reservoirs may include different medical liquids in a specified ratio to create a desired mixture in an easy and efficient manner. For example, depressing an actuator cap may increase a pressure within the second reservoir such that a flow preventer, such as a rubber stopper, is dislodged from blocking fluid communication between the first and second reservoirs. In one or more embodiments, the flow preventer may be dislodged into the first reservoir to enable sanitary and reliable disposal. In various embodiments, the MLPD may include a safety clip to prevent erroneous activation of the actuator. In many embodiments, by keeping the contents of the first and second reservoirs separated, until immediately prior to administration, the shelf-life and availability of the mixture can be improved. In many such embodiments, this can be achieved while still providing intuitive, safe, and reliable mixing of the liquids. In these and other ways one or more of the MLPDs described herein may function in a safe and efficient manner to achieve a better performing MLPD, resulting in several technical effects and advantages.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

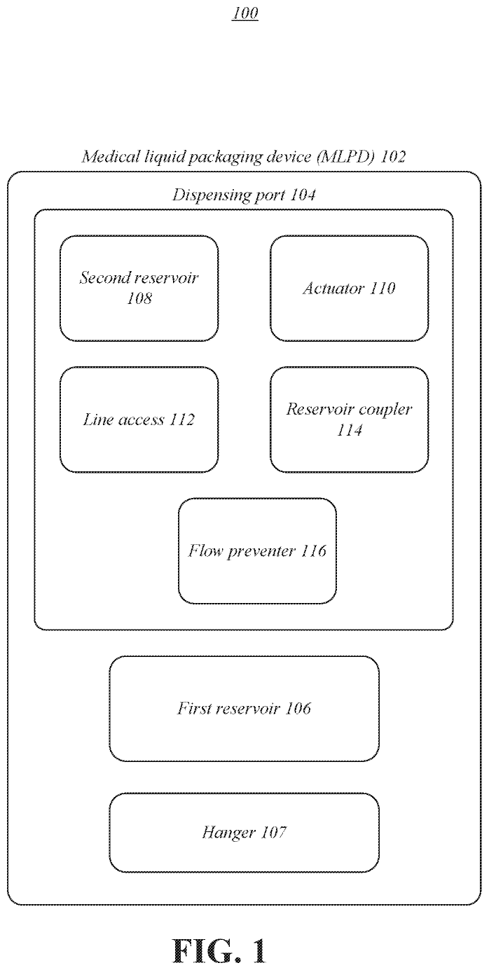

FIG. 1 illustrates an embodiment of an operating environment 100 that may be representative of various embodiments. Operating environment 100 may include a medical liquid packaging device (MLPD) 102. In some embodiments, MLPD 102 may be utilized in an ocular surgery (e.g., to provide irrigation or infusion fluid for the eye). The MLPD 102 may include a dispensing port 104, a first reservoir 106, and a hanger 107. In various embodiments, the dispensing port 104 may include a second reservoir 108, an actuator 110, a line access 112, a reservoir coupler 114, and a flow preventer 116. In one or more embodiments described herein, actuator 110 may be selectively utilized to dislodge flow preventer 116 from blocking fluid communication between the first reservoir 106 and the second reservoir 108. In one or more such embodiments, the contents of the first and second reservoirs 106, 108 may combine to form a mixture or solution, such as an irrigating solution. Embodiments are not limited in this context.

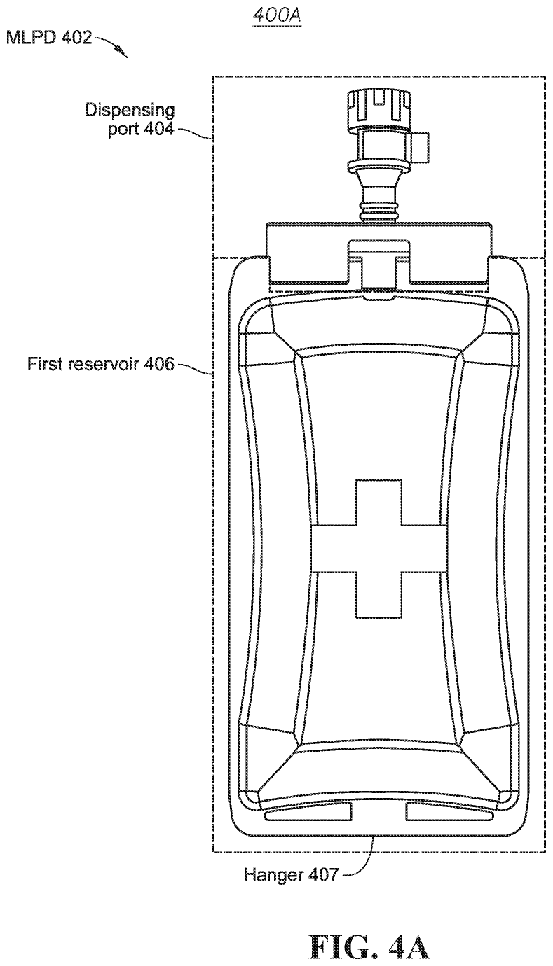

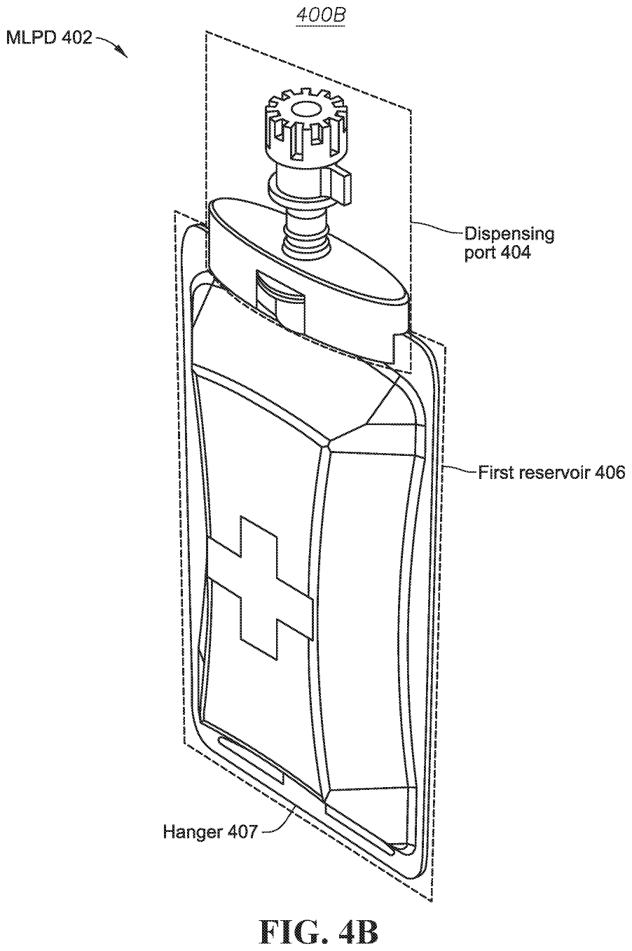

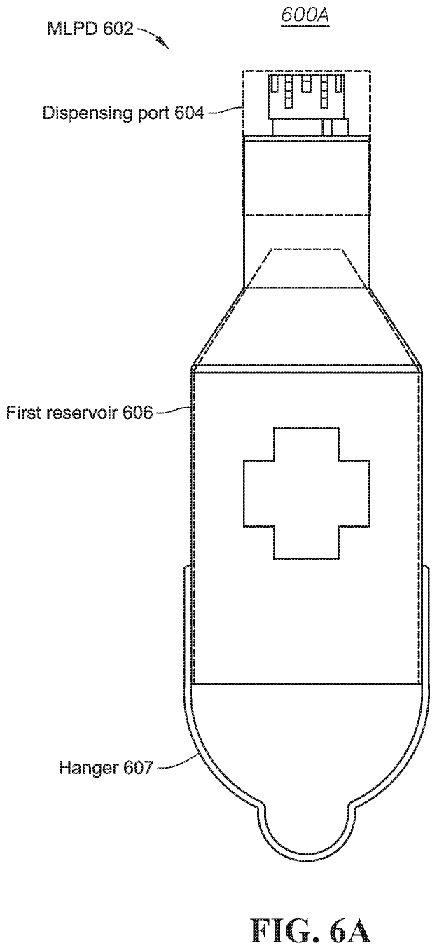

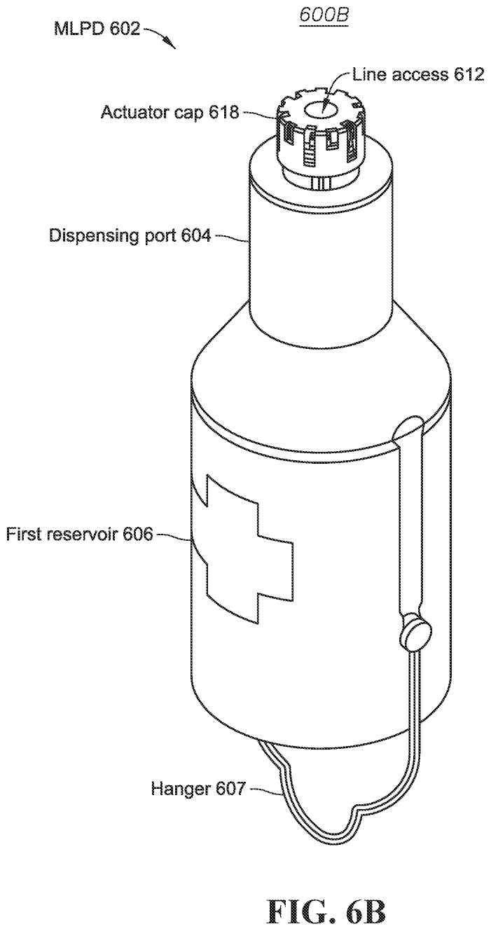

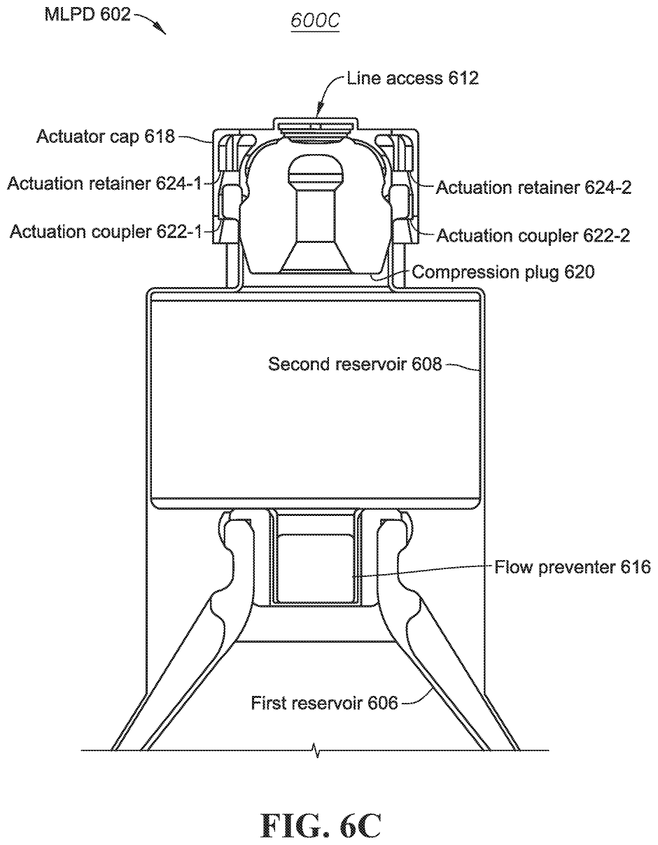

In many embodiments, MLPD 102 may be a device that can be used for storage, mixing, and dispensing two different liquid products. In many such embodiments, MLPD 102 may provide an intuitive and efficient manner of combining two different medical liquids for bag presentations (see e.g., FIGS. 4A and 4B) and glass presentations (see e.g., FIGS. 6A and 6B). In some embodiments, mixing two medical liquids via MLPD 102 may be referred to as the transfer method. In some such embodiments, the transfer method may operate according to positive displacement. In other words, a buildup of pressure may cause fluid communication between the first and second reservoirs 106, 108 to be established. For instance, the transfer method may include a physical act of depressing a portion of actuator 110.

In some instances, depressing the portion of the actuator 110 may displace flow preventer 116 from blocking fluid communication between the first reservoir 106 and the second reservoir 108. For example, depressing the portion of actuator 110 may increase a pressure difference between the first and second reservoirs 106, 108. In such examples, the pressure difference between the first and second reservoirs 106, 108 may dislodge flow preventer 116 from blocking fluid communication between the reservoirs. In some embodiments, flow preventer 116 may be dislodged into first reservoir 106. In one or more embodiments, first and second reservoirs 106, 108 may be referred to as reservoirs 106, 108.

In many embodiments, the second reservoir 108 may be shaped to promote the flow of a liquid from the second reservoir 108 to the first reservoir 106, such as when flow preventer 116 is dislodged into first reservoir 106. Similarly, in some embodiments, the second reservoir 108 may be shaped to promote flow of a liquid from second reservoir 108 toward line access 112, such as when MLPD 102 is inverted. For instance, portions of second reservoir 108 may be sloped toward a desired flow direction. In various instances, portion of second reservoir 108 may be sloped toward a desired flow direction based on orientation of MLPD 102.

In many instances, displacing flow preventer 116 may establish fluid communication between the first and second reservoirs 106, 108 such that the liquids can combine. For instance, a second liquid stored in the second reservoir 108 may flow down into the first reservoir 106 to mix with a first liquid stored in the first reservoir 106. In various embodiments, the solution of medical liquids may include a balanced salt solution (BSS). In various such embodiments, the BSS may be a sterile irrigating solution. In some embodiments, hanging MLPD 102 via hanger 107 may invert the first and second reservoirs 106, 108 such that the solution fills the second reservoir 108 with overflow residing in the first reservoir 106. In some such embodiments, hanging MLPD 102 via hanger 107 may further mix the different liquids prior to administration to a patient.

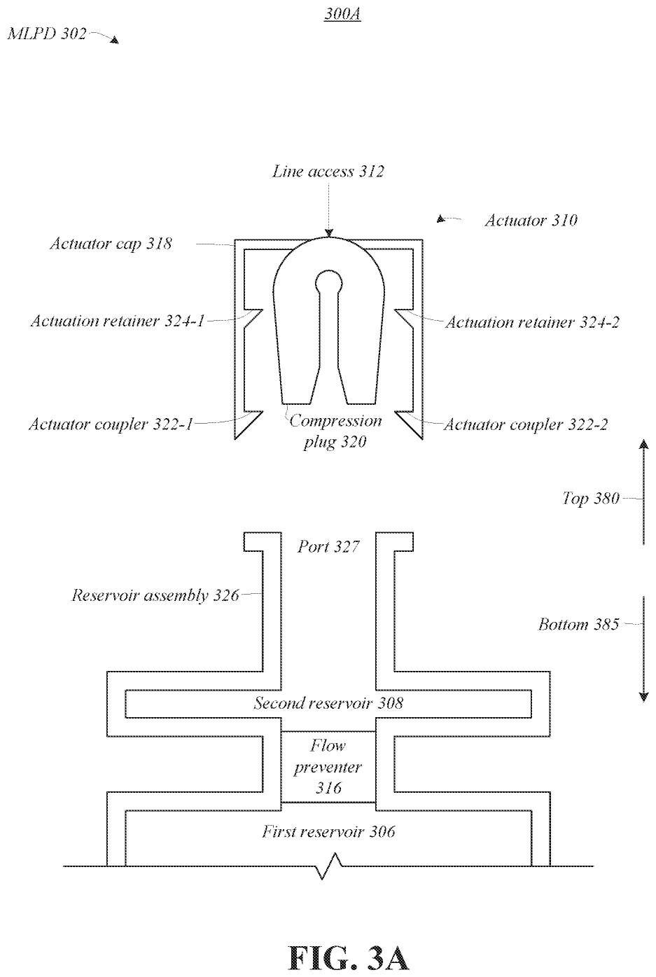

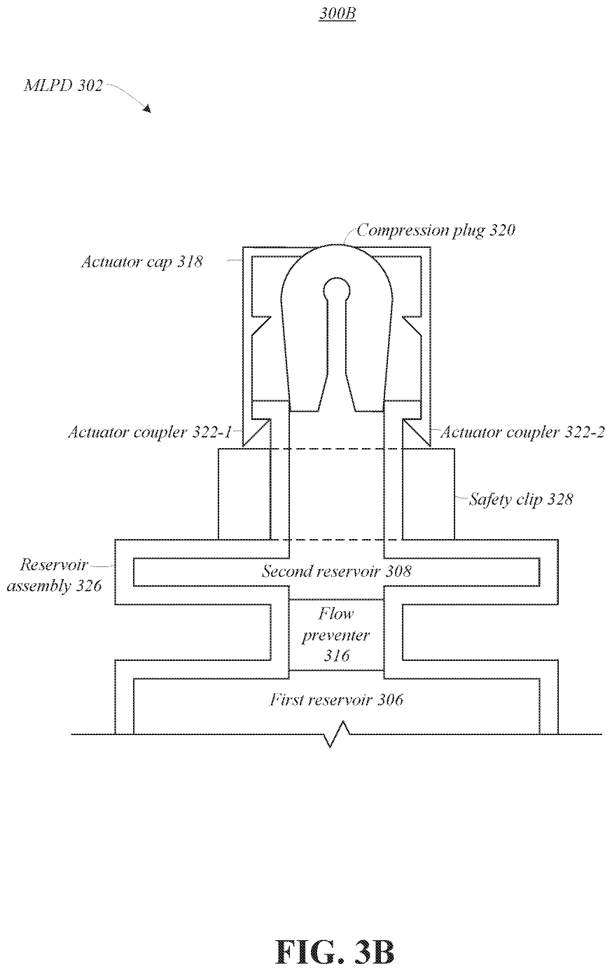

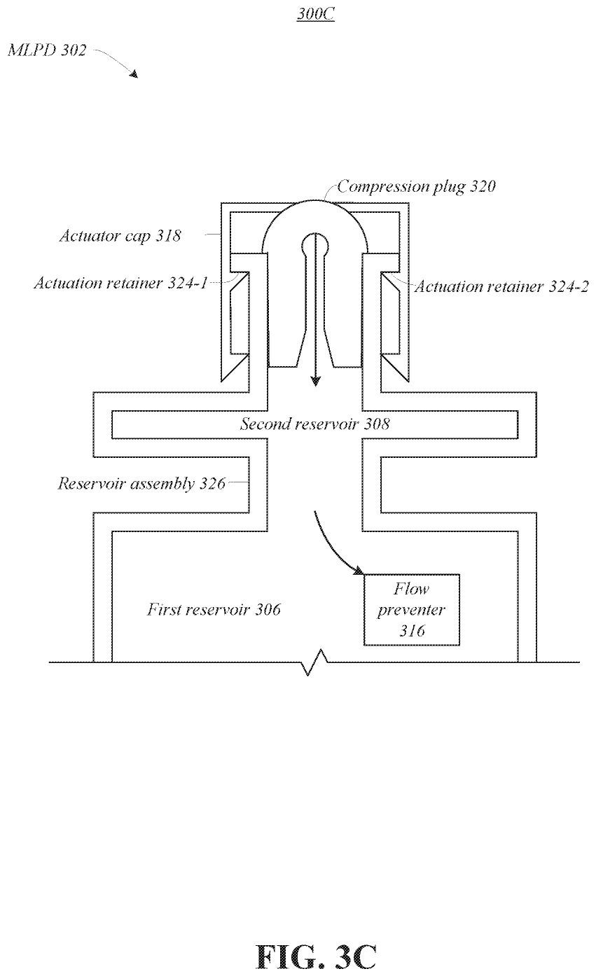

In one or more embodiments, the line access 112 of dispensing port 110 may be utilized to administer the solution to a patient. For instance, line access 112 may enable a needle, such as one utilized in conjunction with an intravenous line, to establish fluid communication with the first and second reservoirs 106, 108. In such instances, the line access 112 may include a portion of MLPD 102 that the needle punctures to establish fluid communication with the reservoirs 106, 108 (see, e.g., a portion of compression plug 320 in FIG. 3). In various embodiments, the needle may establish fluid communication with first reservoir 106, via second reservoir 108.

In various embodiments, reservoir coupler 114 may be used to connect dispensing port 104 to first reservoir 106. For example, reservoir coupler 114 may utilize male/female threads that match with female/male threads on the first reservoir 106. In some such examples, first reservoir 106 may include a glass or bag presentation. Other coupling mechanisms, such as snap fitting, friction fitting, and other known coupling mechanisms may be used. In one or more embodiments, flow preventer 116 may be disposed within or proximate to reservoir coupler 114 to block fluid communication between the first and second reservoirs 106, 108. In some embodiments, the first reservoir 106 may be larger than the second reservoir 108. For example, the first reservoir 106 may hold 480 milliliters of medical liquid, while the second reservoir 108 may hold 20 milliliters. In one or more embodiments, the first reservoir 106 may include a sterile irrigating solution, and the second reservoir 108 may include an irrigating solution additive.

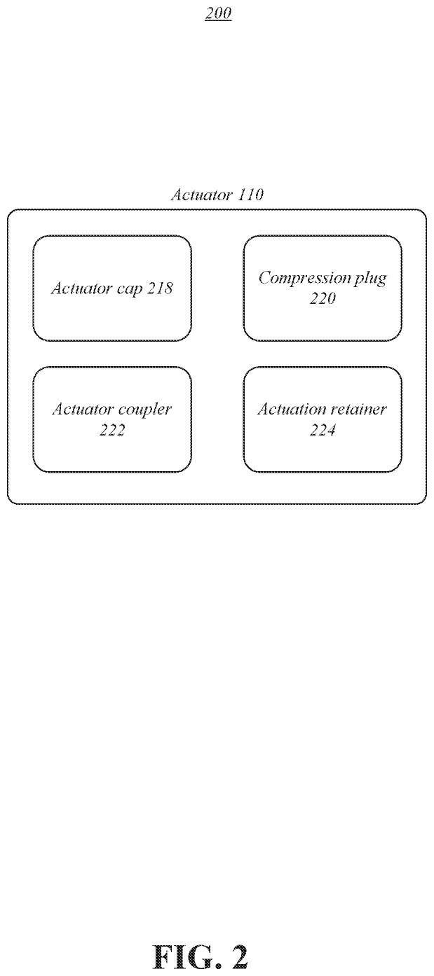

FIG. 2 illustrates an embodiment of an operating environment 200 that may be representative of various embodiments. Operating environment 200 may include actuator 110. In the illustrated embodiments, actuator 110 includes actuator cap 218, compression plug 220, actuator coupler 222, and actuation retainer 224. In one or more embodiments described herein, the components of actuator 110 may operate to efficiently store, mix, and/or dispense medical liquids or solutions. For example, actuator 110 may enable the contents of first reservoir 106 to mix with second reservoir 108 by displacing flow preventer 116 from blocking fluid communication between the reservoirs 106, 108. In many embodiments, actuator 110 may dislodge flow preventer 116 from between the reservoirs, 106, 108 by causing the pressure difference between the first and second reservoirs 106, 108 to increase. Embodiments are not limited in this context.

In various embodiments, actuator 110 may include at least a first state and a second state. In some such embodiments, the first state may include when flow preventer 116 blocks fluid communication between the first and second reservoirs 106, 108. In one or more such embodiments, the second state may include when flow preventer 116 does not block fluid communication between the first and second reservoirs 106, 108 such that any liquids disposed therein can mix together.

In some embodiments, transitioning from the first state to the second state may proceed as follows. Actuator cap 218 may be depressed toward second reservoir 108. In such embodiments, depressing actuator cap 218 may force at least a portion of compression plug 220 into second reservoir 108. In various embodiments, forcing the compression plug 220 or a portion of compression plug 220 into second reservoir 108 may increase the pressure difference between the first and second reservoirs 106, 108 such that flow preventer 116 is pushed into first reservoir 106. In one or more embodiments, actuator coupler 222 may connect actuator 110 with dispensing port 104 when actuator 110 is in the first state. In one or more such embodiments, a safety clip (see e.g., safety clip 328 in FIG. 3B) may be used to prevent actuator 110 from accidentally transitioning from the first to second state. In various embodiments, actuation retainer 224 may connect actuator 110 with dispensing port 104 when actuator is in the second state. In various such embodiments, actuation retainer 224 may prevent the increased pressure in the second reservoir 108 from pushing compression plug 220 out to decrease the pressure in second reservoir 108.

FIGS. 3A-3C illustrate exemplary operational states 300A, 300B, 300C of an MLPD 302 that may be representative of various embodiments. In the illustrated embodiments, MLPD 302 may include actuator 310 and reservoir assembly 326. In some embodiments, MLPD 302 and/or one or more components thereof may be the same or similar to one or more other MLPDs and/or one or more components thereof described herein. For instance, second reservoir 308 may be the same as second reservoir 108. In operational state 300A, actuator 310 may be detached from reservoir assembly 326, and flow preventer 316 may be disposed between first reservoir 306 and second reservoir 308 to block fluid communication therebetween. In operational state 300B, actuator 310 may be attached to reservoir assembly 326 via actuator couplers 322-1, 322-2, and flow preventer 316 may be disposed between first reservoir 306 and second reservoir 308 to block fluid communication therebetween. In operational state 300C, actuator may be attached to reservoir assembly 326 via actuation retainers 324-1, 324-2, and flow preventer 316 may be displaced from between first reservoir 306 and second reservoir 308 such that the reservoirs 306, 308 are in fluid communication. Embodiments are not limited in this context.

Referring to operational state 300A of FIG. 3A, actuator 310 may be separate from reservoir assembly 326. In various embodiments, reservoir assembly 326 may include first reservoir 306, second reservoir 308, and port 327. In operational state 300A, flow preventer 316 may be disposed between the first and second reservoirs 306, 308 to block fluid communication therebetween. It will be appreciated that operational state 300A is presented for illustrative purposes and may not be a configuration utilized during operation of MLPD 302. For instance, actuator 310 may be included in dispensing port 104 prior to coupling dispensing port 104 to first reservoir 106 via reservoir coupler 114. In another instance, reservoir assembly 326 may not appear separate from actuator 310. As shown in FIG. 3A, each of the actuator 310 and reservoir assembly 326 may have top and bottom ends 380, 385. For example, the first reservoir 306 may be disposed proximate the bottom end 385 of reservoir assembly 326, and port 327 may be at the top end 380 of reservoir assembly 326. In another example, line access 312 may be located at the top end 380 of actuator 310, and actuator couplers 322-1, 322-2 are at the bottom end 385 of actuator 310.

Referring to operational state 300B of FIG. 3B, actuator 310 may be coupled to reservoir assembly 326. In operational state 300B, as in operational state 300A, flow preventer 316 may be disposed between the first and second reservoirs 306, 308 to block fluid communication therebetween. In some embodiments, actuator 310 may be coupled to reservoir assembly 326 via actuator couplers 322-1, 322-2. In various embodiments, actuator couplers 322-1, 322-2 may be able to flex out and away from compression plug 320 to fit onto and/or couple with reservoir assembly 326. In various such embodiments, one or more portions of actuator cap 318 may include a semi-rigid material to enable actuator couplers 322-1, 322-2 (and/or actuation retainers 324-1, 324-2) sufficient flexibility to fit over the top end 380 of reservoir assembly 326 while still having enough rigidity to maintain a connection between actuator 310 and reservoir assembly 326.

In one or more embodiments, in operational state 300B, compression plug 320 may be inserted into and create a seal with port 327. In one or more such embodiments, the seal may prevent any contents of second reservoir 308 from leaking out. In some embodiments, inserting compression plug 320 into port 327 may trap an air bubble in second reservoir 308 with a medical liquid and/or a portion of compression plug 320. As will be described in more detail below (see e.g., FIG. 3C), in various embodiments, compression of the air bubble by depressing actuator cap 318 toward the bottom end 385 of MLPD 302 may cause flow preventer 316 to be dislodged from between the first and second reservoirs 306, 308. In the illustrated embodiments, a safety clip 328 may be attached to reservoir assembly 326 to prevent unintentional depression of actuator cap 318.

Referring to operational state 300C of FIG. 3C, actuator 310 may be coupled to reservoir assembly 326. In operational state 300C, actuator cap 318 may be depressed such that flow preventer 316 is dislodged from between the first and second reservoirs 306, 308 to allow fluid communication therebetween. In various embodiments, actuator cap 318 may be maintained in the depressed state via actuation retainers 324-1, 324-2. In some embodiments, actuator 310 may be coupled to reservoir assembly 326 via actuation retainers 324-1, 324-2. In various embodiments, actuation retainers 324-1, 324-2 may be able to flex out and away from compression plug 320 to couple with reservoir assembly 326. In various such embodiments, one or more portions of actuator cap 318 may include a semi-rigid material to enable actuator couplers 322-1, 322-2 sufficient flexibility to fit over the top end 380 of reservoir assembly 326 while still having enough rigidity to maintain a connection between actuator 310 and reservoir assembly 326. In some embodiments, safety clip 328 may be removed prior to depressing actuator 310.

In one or more embodiments, in operational state 300C, actuator 310 may be depressed (e.g., via actuator cap 318) such that a pressure in second reservoir 308 increases as compression plug 320 extends further into second reservoir 308 via port 327. In one or more such embodiments, this may increase the pressure in the second reservoir 308. In various embodiments, when the pressure difference between the first reservoir 306 and the second reservoir 308 is high enough, flow preventer 316 may be dislodged from between the first and second reservoirs 306, 308. As previously mentioned with respect to operational state 300B, in some embodiments, inserting compression plug 320 into port 327 may trap an air bubble in second reservoir 308 with a medical liquid and/or a portion of compression plug 320.

In various embodiments, compression of the air bubble by depressing actuator cap 318 toward the bottom end 385 of MLPD 302 may cause flow preventer 316 to be dislodged from between the first and second reservoirs 306, 308. In many embodiments, flow preventer 316 may be dislodged from between first and second reservoirs 306, 308 and into first reservoir 306. In one or more embodiments, a needle may be inserted through line access 312 to gain access to the first and second reservoirs 306, 308, such as for an intravenous therapy. In one or more such embodiments, line access 312 may form a portion of compression plug 320. For example, compression plug 320 may include rubber that can be punctured by the needle.

FIGS. 4A and 4B illustrate operating environments 400A, 400B that may be representative of various embodiments. Operating environment 400A may include a front view of MLPD 402. Operating environment 400B may include a side perspective view of MLPD 402. In one or more embodiments, MLPD 402 and/or one or more components thereof may be the same or similar to one or more other MLPDs and/or one or more components thereof described herein. For instance, dispensing port 404 may be the same as dispensing port 104. In the illustrated embodiments, MLPD 402 may utilize a bag presentation of first reservoir 406. In various embodiments, MLPD 402 may include dispensing port 404, first reservoir 406, and hanger 407. Embodiments are not limited in this context.

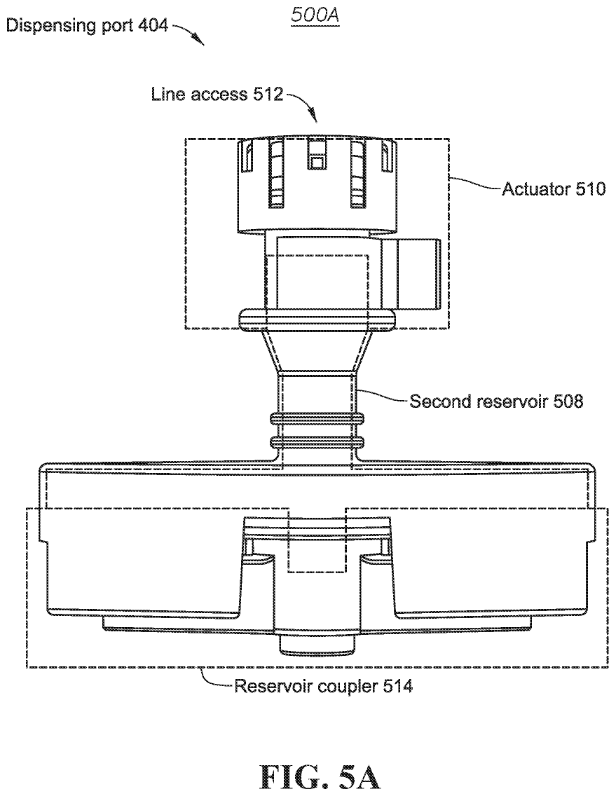

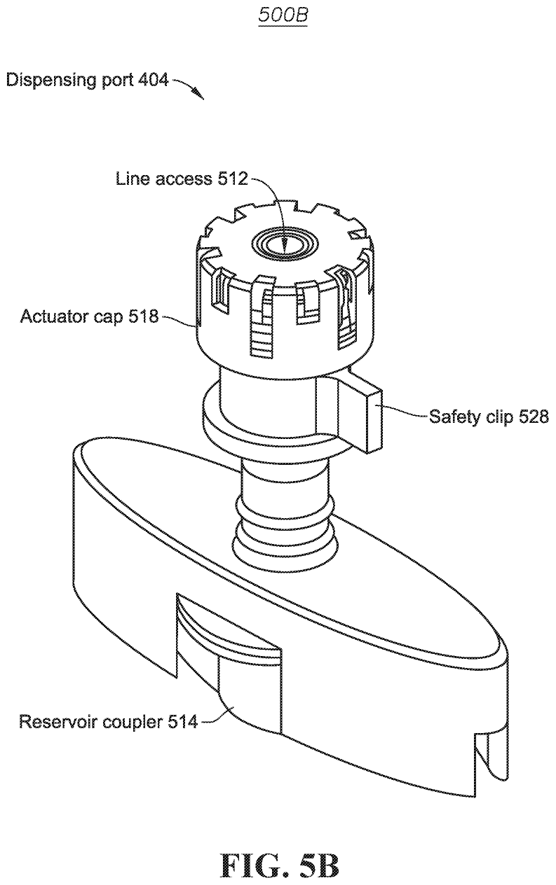

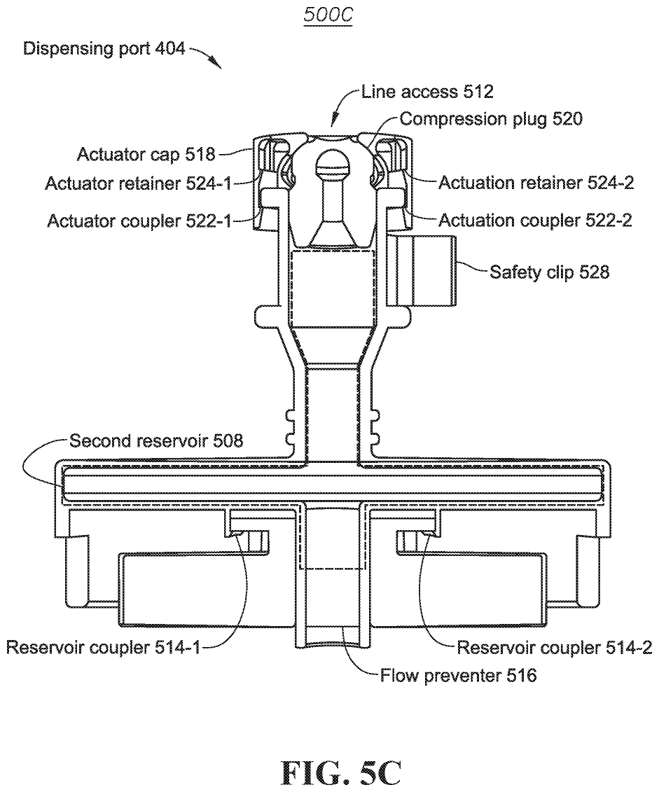

FIGS. 5A-5C illustrate operating environments 500A, 500B, 500C that may be representative of various embodiments. Operating environment 500A may include a front view of dispensing port 404. Operating environment 500B may include a side perspective view of dispensing port 404. Operating environment 500C may include a front cross-sectional view of dispensing port 404. In one or more embodiments, dispensing port 404 and/or one or more components thereof may be the same or similar to one or more other dispensing ports and/or one or more components thereof described herein. For instance, compression plug 520 may be the same as compression plug 320. In various embodiments, dispensing port 404 may be coupled with a first reservoir, such as first reservoir 406 (see e.g., FIGS. 4A and 4B). Embodiments are not limited in this context.

In operating environment 500A, dispensing port 404 may include second reservoir 508, actuator 510, line access 512, and reservoir coupler 514. In operating environment 500B, dispensing port 404 may include actuator cap 518 and safety clip 528 in addition to line access 512 and reservoir coupler 514. In various embodiments, reservoir coupler 514 may be used to attach dispensing port 404 to first reservoir 406. In some embodiments, reservoir coupler 514 may utilize male/female threads that correspond to female/male threads on a first reservoir to attach to the first reservoir. In one or more embodiments, reservoir coupler 514 may operate in the same or an analogous manner as actuator couplers 322-1, 322-2 (see e.g., FIG. 5C). In various embodiments, safety clip 528 may prevent unintentional depression of actuator cap 518.

In operating environment 500C, dispensing port 404 may include second reservoir 508, reservoir couplers 514-1, 514-2, flow preventer 516, compression plug 520, actuator couplers 522-1, 522-2, and actuation retainers 524-1, 524-2 in addition to line access 512, actuator cap 518, and safety clip 528. In some embodiments, reservoir coupler 514 may include reservoir couplers 514-1, 514-2. In one or more embodiments, dispensing port 404 may operate in the same or an analogous manner as illustrated in FIGS. 3B and 3C. Accordingly, in various embodiments, dispensing port 404 may be in operational state 300B of FIG. 3B.

FIGS. 6A-6C illustrate operating environments 600A, 600B, 600C that may be representative of various embodiments. Operating environment 600A may include a front view of MLPD 602. Operating environment 600B may include a side perspective view of MLPD 602. Operating environment 600C may include a cross-sectional view of a top portion of MLPD 602. In one or more embodiments, MLPD 602 and/or one or more components thereof may be the same or similar to one or more other MLPDs and/or one or more components thereof described herein. For instance, actuator cap 618 may be the same as actuator cap 318. In the illustrated embodiments, MLPD 602 may utilize a glass presentation of first reservoir 606. Embodiments are not limited in this context.

In operating environment 600A, MLPD 602 may include dispensing port 604, first reservoir 606, and hanger 607. In operating environment 600B, MLPD 602 may include line access 612 and actuator cap 618 in addition to dispensing port 604, first reservoir 606, and hanger 607. In operating environment 600C, MLPD 602 may include second reservoir 608, flow preventer 616, compression plug 620, actuator coupler 622-1, 622-2, and actuation retainer 624-1, 624-2. In one or more embodiments, MLPD 602 may operate in the same or an analogous manner as MLPD 302 illustrated in FIGS. 3B and 3C. Accordingly, in various embodiments, MLPD 602 may be in operational state 300B of FIG. 3B.

The following examples pertain to further embodiments, from which numerous permutations and configurations will be apparent.

Example 1 is a device for medical liquid packaging, the device comprising: a first reservoir for storing a first liquid; a second reservoir for storing a second liquid; a flow preventer disposed between the first and second reservoirs to block fluid communication therebetween; and an actuator coupled to a port in fluid communication with the second reservoir; wherein the actuator is movable from a first state to a second state, wherein in the first state the flow preventer is disposed between the first and second reservoirs to block fluid communication therebetween, and, in the second state, the flow preventer is dislodged from between the first and second reservoirs to allow fluid communication therebetween.

Example 2 includes the subject matter of Example 1, wherein transitioning the actuator from the first state to the second state comprises displacing the actuator toward the second reservoir.

Example 3 includes the subject matter of Example 1, wherein transitioning the actuator from the first state to the second state increases a pressure within the second reservoir to dislodge the flow preventer from between the first and second reservoirs.

Example 4 includes the subject matter of Example 1, wherein the actuator comprises a compression plug, and wherein transitioning the actuator from the first state to the second state forces the compression plug into the port toward the second reservoir.

Example 5 includes the subject matter of Example 1, wherein the actuator comprises a compression plug, and wherein transitioning the actuator from the first state to the second state forces the compression plug into a portion of the second reservoir to dislodge the flow preventer from between the first and second reservoirs.

Example 6 includes the subject matter of Example 1, wherein in the second state the flow preventer is dislodged from between the first and second reservoirs into the first reservoir.

Example 7 includes the subject matter of Example 1, wherein in the first state the first liquid is in the first reservoir and the second liquid is in the second reservoir, and wherein dislodging the flow preventer from between the first and second reservoirs causes the second liquid to flow into the first reservoir.

Example 8 includes the subject matter of Example 1, wherein the actuator comprises an actuator cap and a compression plug, and wherein displacing the actuator cap toward the second reservoir transitions the actuator from the first state to the second state, forcing the compression plug into a portion of the second reservoir.

Example 9 includes the subject matter of Example 1, wherein the actuator comprises one or more actuator couplers to couple the actuator to the port in the first state.

Example 10 includes the subject matter of Example 1, wherein the actuator comprises one or more actuation retainers to couple the actuator to the port in the second state.

Example 11 includes the subject matter of Example 1, further comprising a dispensing port that includes the second reservoir, the actuator, and a line access, the line access configured to enable a needle to be inserted through the actuator and placed in fluid communication with the second reservoir.

Example 12 includes the subject matter of Example 1, further comprising a dispensing port that includes the second reservoir, the actuator, and a reservoir coupler, the reservoir coupler configured to connect the first reservoir to the second reservoir.

Example 13 includes the subject matter of Example 1, further comprising a safety clip wherein the safety clip prevents the actuator from transitioning from the first state to the second state.

Example 14 is a method for combining medical liquids, the method comprising: moving an actuator from a first state to a second state, wherein the first state includes a flow preventer disposed between a first reservoir with a first liquid and a second reservoir with a second liquid to block fluid communication therebetween; and dislodging the flow preventer from between the first and second reservoirs by moving the actuator from the first state to the second state to allow fluid communication between the first and second reservoirs, wherein the actuator is coupled to a port in fluid communication with the second reservoir.

Example 15 includes the subject matter of Example 14, wherein moving the actuator from the first state to the second state comprises displacing the actuator toward the second reservoir.

Example 16 includes the subject matter of Example 14, wherein moving the actuator from the first state to the second state increases a pressure within the second reservoir to dislodge the flow preventer from between the first and second reservoirs.

Example 17 includes the subject matter of Example 14, wherein the actuator comprises a compression plug, and wherein moving the actuator from the first state to the second state forces the compression plug into the port toward the second reservoir.

Example 18 includes the subject matter of Example 14, wherein the actuator comprises a compression plug, and wherein moving the actuator from the first state to the second state forces the compression plug into a portion of the second reservoir to dislodge the flow preventer from between the first and second reservoirs.

Example 19 includes the subject matter of Example 14, wherein in the second state the flow preventer is dislodged from between the first and second reservoirs into the first reservoir.

Example 20 includes the subject matter of Example 14, wherein in the first state the first liquid is in the first reservoir and the second liquid is in the second reservoir, and wherein dislodging the flow preventer from between the first and second reservoirs causes the second liquid to flow into the first reservoir.

Example 21 is a device for medical liquid packaging, the device comprising: a reservoir assembly comprising a top end and a bottom end, the top end to include a port; a primary reservoir disposed within the reservoir assembly proximate the bottom end, the primary reservoir for storing a first liquid; a secondary reservoir disposed within the reservoir assembly proximate the top of the reservoir assembly, the secondary reservoir for storing a second liquid, wherein the secondary reservoir is accessible via the port; a flow preventer disposed between the primary and secondary reservoirs, wherein the flow preventer blocks fluid communication between the primary and secondary reservoirs; a fluid combiner coupled to the port of the reservoir assembly via one or more actuator couplers, wherein displacing the fluid combiner toward the bottom end of the reservoir assembly dislodges the flow preventer from between the primary and secondary reservoirs to place the primary and secondary reservoirs in fluid communication.

Example 22 includes the subject matter of Example 21, wherein displacing the fluid combiner toward the bottom end of the reservoir increases a pressure within the secondary reservoir to dislodge the flow preventer from between the primary and secondary reservoirs.

Example 23 includes the subject matter of Example 21, wherein displacing the fluid combiner toward the bottom end of the reservoir dislodges the flow preventer from between the primary and secondary reservoirs into the primary reservoir.

Example 24 includes the subject matter of Example 21, wherein dislodging the flow preventer form between the primary and secondary reservoirs causes the second liquid to flow into the primary reservoir.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A device for medical liquid packaging, the device comprising:
a first reservoir;
a second reservoir;
a flow preventer disposed between the first and second reservoirs to block fluid communication therebetween; and
an actuator coupled to a port in fluid communication with the second reservoir;
wherein the actuator is movable from a first state to a second state, wherein in the first state the flow preventer is disposed between the first and second reservoirs to block fluid communication therebetween, and, in the second state, the flow preventer is dislodged from between the first and second reservoirs to allow fluid communication therebetween.

2. The device of claim 1, wherein transitioning the actuator from the first state to the second state comprises displacing the actuator toward the second reservoir.

3. The device of claim 1, wherein transitioning the actuator from the first state to the second state increases a pressure within the second reservoir to dislodge the flow preventer from between the first and second reservoirs.

4. The device of claim 1, wherein the actuator comprises a compression plug, and wherein transitioning the actuator from the first state to the second state forces the compression plug into the port toward the second reservoir.

5. The device of claim 1, wherein the actuator comprises a compression plug, and wherein transitioning the actuator from the first state to the second state forces the compression plug into a portion of the second reservoir to dislodge the flow preventer from between the first and second reservoirs.

6. The device of claim 1, wherein in the second state the flow preventer is dislodged from between the first and second reservoirs into the first reservoir.

7. The device of claim 1, wherein in the first state a first liquid is in the first reservoir and a second liquid is in the second reservoir, and wherein dislodging the flow preventer from between the first and second reservoirs causes the second liquid to flow into the first reservoir.

8. The device of claim 1, wherein the actuator comprises an actuator cap and a compression plug, and wherein displacing the actuator cap toward the second reservoir transitions the actuator from the first state to the second state, forcing the compression plug into a portion of the second reservoir.

9. The device of claim 1, wherein the actuator comprises one or more actuator couplers to couple the actuator to the port in the first state.

10. The device of claim 1, wherein the actuator comprises one or more actuation retainers to couple the actuator to the port in the second state.

11. The device of claim 1, further comprising a dispensing port that includes the second reservoir, the actuator, and a line access, the line access configured to enable a needle to be inserted through the actuator and placed in fluid communication with the second reservoir.

12. The device of claim 1, further comprising a dispensing port that includes the second reservoir, the actuator, and a reservoir coupler, the reservoir coupler configured to connect the first reservoir to the second reservoir.

13. The device of claim 1, further comprising a safety clip wherein the safety clip prevents the actuator from transitioning from the first state to the second state.

14. A method for combining medical liquids, the method comprising:
moving an actuator from a first state to a second state, wherein the first state includes a flow preventer disposed between a first reservoir with a first liquid and a second reservoir with a second liquid to block fluid communication therebetween; and
dislodging the flow preventer from between the first and second reservoirs by moving the actuator from the first state to the second state to allow fluid communication between the first and second reservoirs, wherein the actuator is coupled to a port in fluid communication with the second reservoir.

15. The method of claim 14, wherein moving the actuator from the first state to the second state comprises displacing the actuator toward the second reservoir.

16. The method of claim 14, wherein moving the actuator from the first state to the second state increases a pressure within the second reservoir to dislodge the flow preventer from between the first and second reservoirs.

17. The method of claim 14, wherein the actuator comprises a compression plug, and wherein moving the actuator from the first state to the second state forces the compression plug into the port toward the second reservoir.

18. The method of claim 14, wherein the actuator comprises a compression plug, and wherein moving the actuator from the first state to the second state forces the compression plug into a portion of the second reservoir to dislodge the flow preventer from between the first and second reservoirs.

19. The method of claim 14, wherein in the second state the flow preventer is dislodged from between the first and second reservoirs into the first reservoir.

20. The method of claim 14, wherein in the first state the first liquid is in the first reservoir and the second liquid is in the second reservoir, and wherein dislodging the flow preventer from between the first and second reservoirs causes the second liquid to flow into the first reservoir.
